(19) United States
(12) Patent Application Publication
(10) Pub. No.: US 2013/0132917 A1
(43) Pub. Date: May 23, 2013

(54) Pattern Matching Hints

(71) Applicant: Mark C. Simmons, Wilsonville, OR (US)

(72) Inventor: Mark C. Simmons, Wilsonville, OR (US)

(73) Assignee: Mentor Graphics Corporation

(21) Appl. No.: 13/300,453

(22) Filed: Nov. 18, 2011

(51) Int. Cl. G06F 17/50

(52) U.S. Cl. 716/106

(57) ABSTRACT

Aspects of the invention relate to techniques for generating and applying pattern matching hints. Pattern matching hints are determined for and stored with reference patterns. Once layout patterns that match a reference pattern are identified in a layout design through a pattern matching process, the corresponding pattern matching hints may be associated with the identified layout patterns. The association operation may comprise adjusting the identified layout patterns based on the corresponding pattern matching hints.

### FIELD OF THE INVENTION

The present invention relates to the field of lithography. Various implementations of the invention may be particularly useful for identifying and repairing problematic patterns in layout designs.

### BACKGROUND OF THE INVENTION

Microdevices, such as integrated circuits, are used in a variety of products, from automobiles to microwaves to personal computers. Designing and fabricating integrated circuit devices typically involves many steps, known as a “design flow.” The particular steps of a design flow often are dependent upon the type of integrated circuit being designed, its complexity, the design team, and the integrated circuit fabricator or foundry that will manufacture the integrated circuit. Typically, software and hardware “tools” will verify a design at various stages of the design flow by running software simulators and/or hardware emulators, and errors in the design are corrected.

Several steps are common to most design flows. Initially, the specification for the new integrated circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices. Layout tools, such as Mentor Graphics' IC Station or Cadence's Virtuoso, are commonly used for both of these tasks.

With a layout design, each physical layer of the integrated circuit will have a corresponding layer representation, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires used will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc. After the layout design has been finalized, then it is converted into a format that can be employed by a mask or reticle writing tool to create a mask or reticle for use in a photolithographic manufacturing process.

Some of these physical verification processes are based on one simple concept: certain geometric shapes cannot be successfully manufactured with a given manufacturing process. Historically, a chip manufacturer would have a failure analysis (FA) team identify these configurations, generate a geometric representation of the problematic features in those configurations, and then derive an engineering specification for excluding those problematic features from new designs. This type of engineering specification typically would be interpreted and formulated as a design rule. The derived design rule would then be added to the rule decks for use during a physical verification process.

The above design rule checking (DRC) process worked well when most problem features could be defined with simple one-dimensional checks (length, width, distance, etc.). However, as the microdevice manufacturing industry reached the advanced nodes of the nanometer era, shapes became more complex, and the interactions between design features became multi-dimensional. Some configurations are now so complex that they could not be accurately described with existing scripting languages. Additionally, significant time and expertise must be spent in the attempt to reach congruence between the original intent of the design rule and its implementation in a DRC process. Moreover, as advanced nodes are being implemented, problematic configurations or patterns are now being identified by designers using lithography simulations well before silicon production and the creation of design rules. These designers also need the ability to capture and transfer problematic configurations to other designers.

Using the original visual representation of a configuration rather than the abstraction and derivation can dramatically simplify the process of defining and transferring information about a problematic configuration (pattern) in a layout design to a designer. Therefore, pattern matching (or pattern detection) is becoming a widely used approach in today's semiconductor industry. While pattern matching techniques facilitate detection of problematic patterns in a layout design, challenges still remain on how to efficiently modify the layout design to make it more manufacturable. Information for repairing problematic patterns may be obtained or validated through manufacturing or simulation processes. However, extensive application of these two processes may not be efficient or practical because these two processes are expensive and time consuming. It is desirable to search for techniques that can provide repair guidelines along with problematic patterns found through pattern matching.

### BRIEF SUMMARY OF THE INVENTION

Aspects of the invention relate to techniques for generating and applying pattern matching hints. With various implementations of the invention, one or more pattern matching hints are determined for each of reference patterns. The reference patterns may be problematic layout patterns that need to be identified from layout designs and adjusted. The pattern matching hints may be guidelines on how to adjust the identified layout patterns. Fabrication, simulation or both may be applied to determine the pattern matching hints. The determined pattern matching hints are stored in a processor-accessible medium and linked to the corresponding reference patterns. A pattern matching process may be conducted on a layout design to identify layout patterns that match a reference pattern. The identified layout patterns are associated with corresponding pattern matching hints. The association operation may comprise outputting or information of the identified layout patterns along with the corresponding pattern matching hints. Alternatively or additionally, the association operation may comprise adjusting the identified layout patterns based on the corresponding pattern matching hints.

### BRIEF DESCRIPTION OF THE DRAWINGS

FIG. 1 illustrates an example of a computing system that may be used to implement various embodiments of the invention.

FIG. 2 illustrates an example of a multi-core processor unit that may be used to implement various embodiments of the invention.

FIG. 3 illustrates a tool for pattern matching hints that may be employed according to various embodiments of the invention.

FIG. 4 illustrates a flowchart describing pattern matching hints methods that may be employed by various embodiments of the invention.

FIG. 5 illustrates an example of a reference pattern.

FIG. 6a illustrates a first pattern matching hint for adjusting the reference pattern shown in FIG. 5.

FIG. 6b illustrates a second pattern matching hint for adjusting the reference pattern shown in FIG. 5.

FIG. 6c illustrates a third pattern matching hint for adjusting the reference pattern shown in FIG. 5.

### DETAILED DESCRIPTION OF THE INVENTION

### General Considerations

Various aspects of the present invention relate to generating and applying pattern matching hints. In the following description, numerous details are set forth for the purpose of explanation. However, one of ordinary skill in the art will realize that the invention may be practiced without the use of these specific details. In other instances, well-known features have not been described in details to avoid obscuring the present invention.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “identify,” “associate” and “determine” to describe the disclosed methods. Such terms are high-level abstractions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

### Exemplary Operating Environment

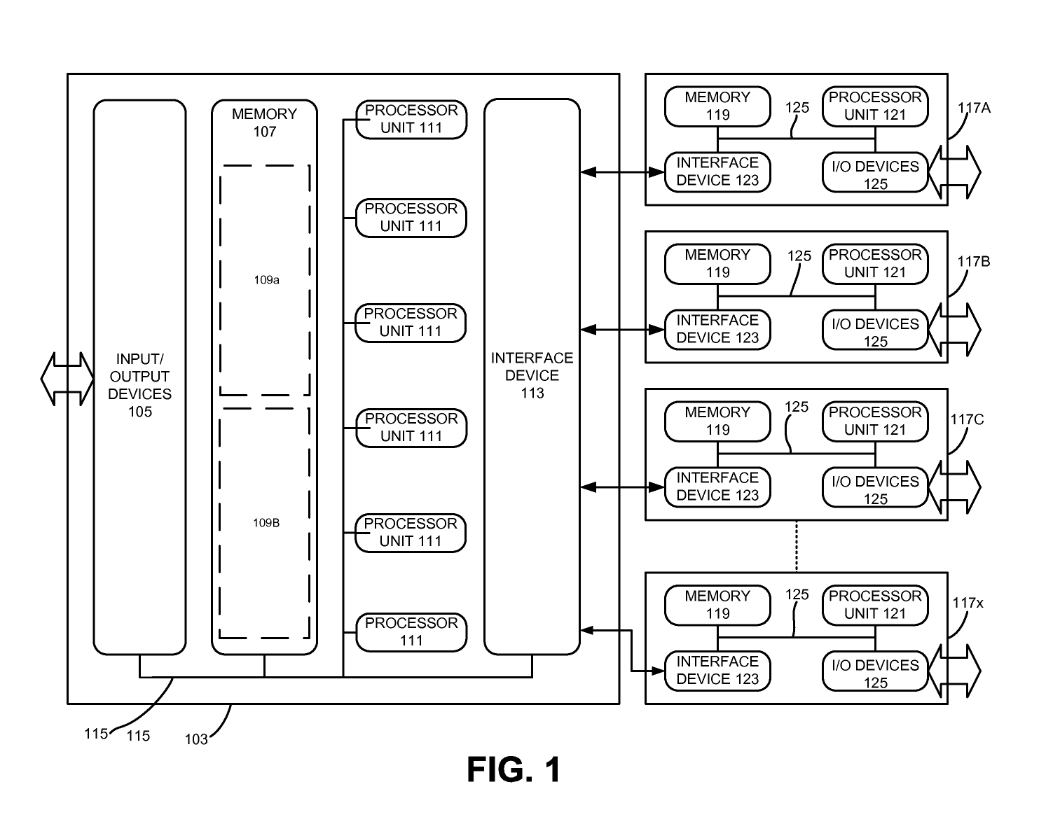

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

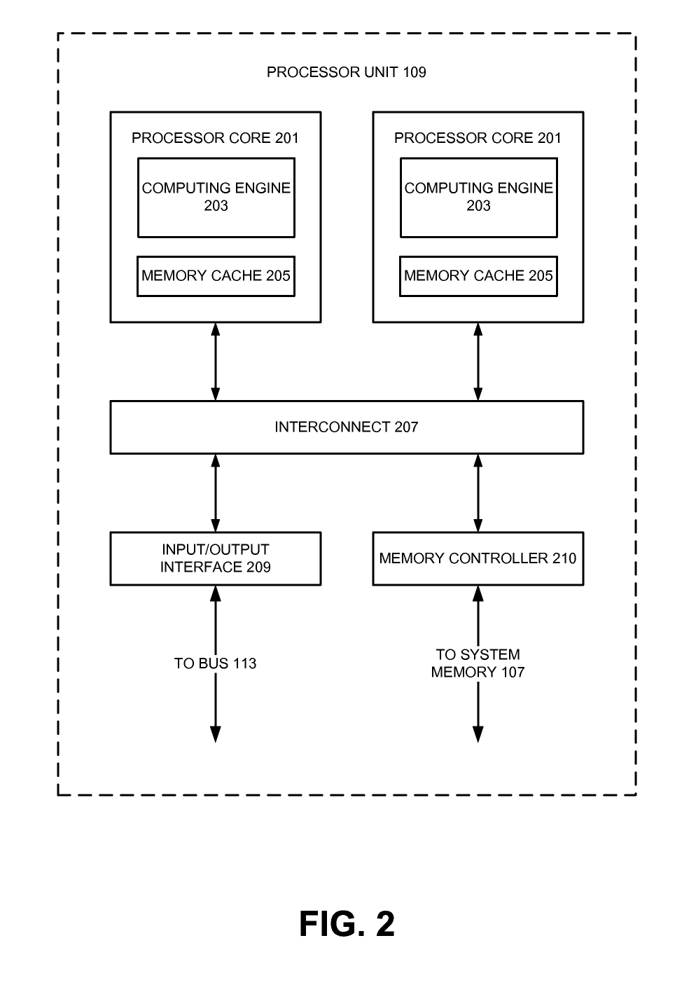

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 17x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Pattern Matching Hints Tools and Methods

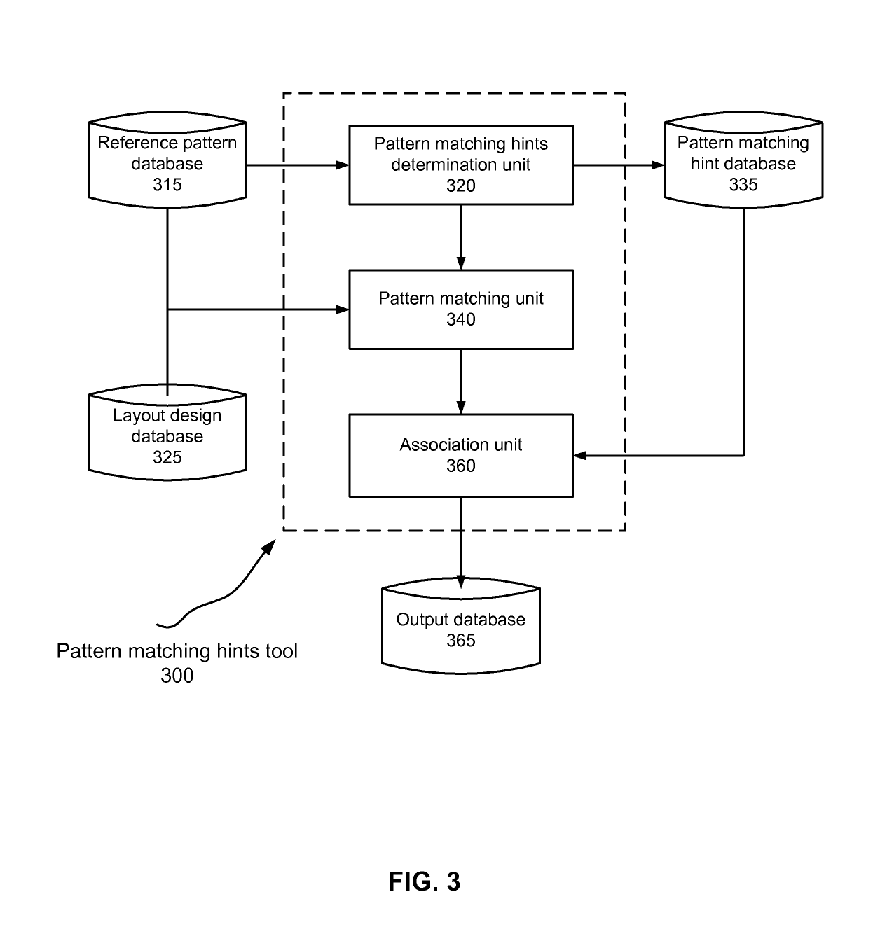

FIG. 3 illustrates an example of a tool for pattern matching hints according to various embodiments of the invention. As seen in the figure, the pattern matching hints tool 300 includes three units: a pattern matching hints determination unit 320, a pattern matching unit 340, and an association unit 360. As will be discussed in more detail below, some implementations of the pattern matching hints tool 300 may cooperate with (or incorporate) one or more of a reference pattern database 315, a layout design database 325, a pattern matching hint database 335, and an output database 365. While the reference pattern database 315, the layout design database 325, the pattern matching hint database 335, and the output database 365 are shown as separate units in FIG. 3, a single data storage medium may be used to implement some or all of these databases.

According to some embodiments of the invention, one or more of the pattern matching hints determination unit 320, the pattern matching unit 340, and the association unit 360 may be implemented by executing programming instructions on one or more programmable computers/computer systems, such as the computing system illustrated in FIG. 1 and FIG. 2. Correspondingly, some other embodiments of the invention may be implemented by software instructions, stored on a non-transitory computer-readable medium, for instructing one or more programmable computers/computer systems to perform the functions of one or more of the pattern matching hints determination unit 320, the pattern matching unit 340, and the association unit 360. As used herein, the term “non-transitory computer-readable medium” refers to computer-readable medium that are capable of storing data for future retrieval, and not just propagating electro-magnetic waves. The non-transitory computer-readable medium may be, for example, a magnetic storage device, an optical storage device, a “punched” surface type device, or a solid state storage device.

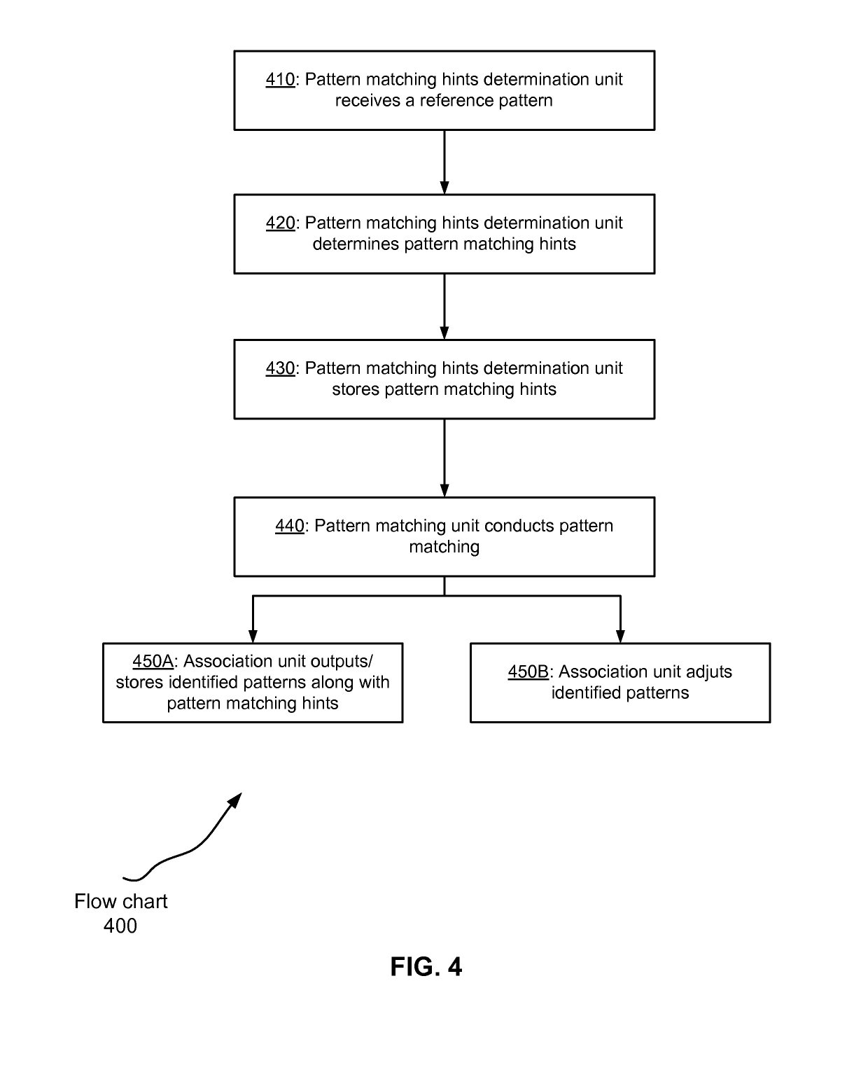

For ease of understanding, hotspot determination methods that may be employed according to various embodiments of the invention will be described with reference to the pattern matching hints tool 300 illustrated in FIG. 3 and the method for pattern matching hints shown in the flow chart 400 in FIG. 4. It should be appreciated, however, that alternate implementations of a pattern matching hints tool may be used to perform the pattern matching hints method shown in the flow chart 400 according to various embodiments of the invention. In addition, it should be appreciated that implementations of the pattern matching hints tool 300 may be employed with other methods for pattern matching hints according to different embodiments of the invention.

Initially, in operation 410, the pattern matching hints determination unit 320 receives layout data for a reference pattern. The reference pattern may be a problematic layout pattern that needs to be identified and repaired. For example, the reference pattern may be a layout pattern prone to pinching or bridging problems if it is printed on a wafer. The reference pattern may also represent devices in a circuit that may affect the circuit's electrical performance such as timing. The reference pattern may be provided by users or chip manufacturers.

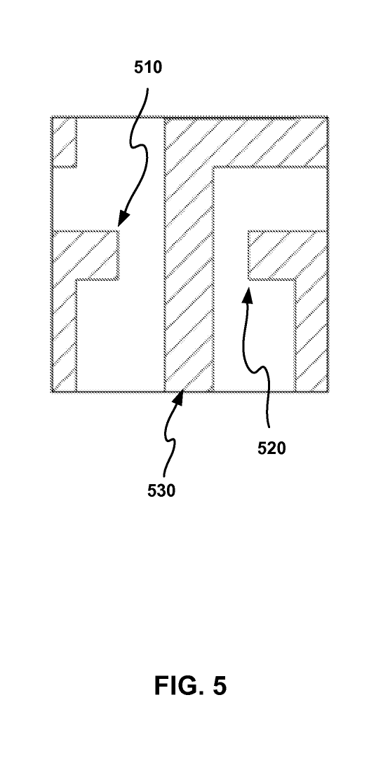

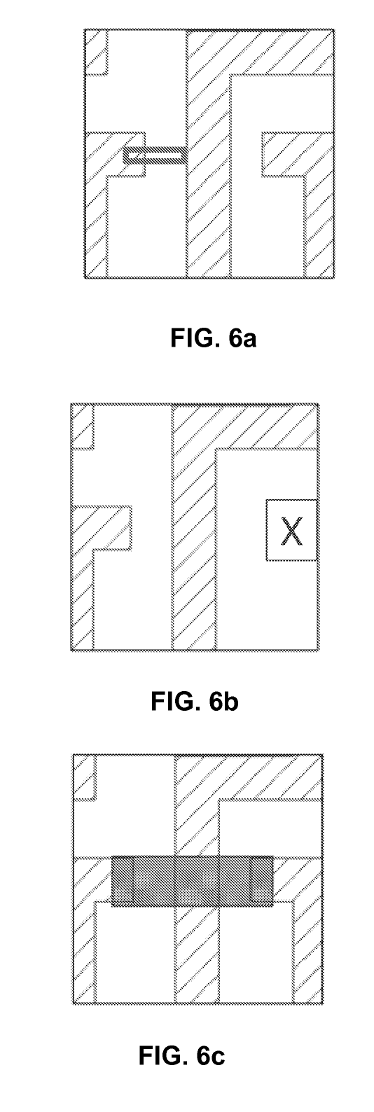

In operation 420, the pattern matching hints determination unit 320 determines one or more pattern matching hints for adjusting the reference pattern. The pattern matching hints may be guidelines on how to adjust the reference pattern to avoid the associated problems. Compared to DRC rules, pattern matching hints may provide pattern-specific repair hints according to some embodiments of the invention. FIG. 5 illustrated an example of a reference pattern. In the reference pattern, the vertical line 530 may be prone to the pinching problem due to two neighboring line ends 510 and 520. FIGS. 6a, 6b and 6c illustrate three different guidelines or pattern matching hints to repair the pinching problem. The hint in FIG. 6a suggests moving the line end 510 to have a minimum distance from the line 530. The hint in FIG. 6b suggests that the line end 520 be moved out of the pattern area. The hint in FIG. 6c suggests that a minimum spacing must be maintained between the two line ends. Different layout designs may choose a hint that works best in their environment. With some implementations of the invention, the hints may be stored and displayed graphically which facilitates the physical verification process.

Various approaches may be adopted by the pattern matching hints determination unit 320 to determine the one or more pattern matching hints. The pattern matching hints determination unit 320 may evaluate hint candidates based on fabrication, simulation or both. The simulation may include lithographic simulation, electrical simulation or both. There are commercial simulation tools that may be employed by the pattern matching hints determination unit 320, such as those in the Calibre family available from Mentor Graphics Corporation of Wilsonville, Oreg. The fabrication may comprise conducting new manufacturing process, using prior manufacturing experience or both. The pattern matching hints determination unit 320 may combine the fabrication and the simulation in the determination process.

In operation 430, the pattern matching hints determination unit 320 may save the determined information in the pattern matching hints database 335. While the reference pattern database 315 and the pattern matching hint database 335 are shown as two separate databases in FIG. 3, the two databases may be combined into a single database. In either way, each reference pattern is linked with corresponding pattern matching hints.

In operation 440, the pattern matching unit 340 identifies layout patterns in a layout design that matches the reference pattern. The layout design may be retrieved from the layout design database 325. The pattern matching unit 340 then use a pattern matching technique to search for the reference pattern in the layout design. Various patent matching techniques may be employed, such as the one disclosed in U.S. patent application Ser. No. 13/068,838, entitled “Fast Pattern Matching,” filed on May 29, 2010 and naming Mark C. Simmons et al. as inventors, which application is incorporated entirely herein by reference.

Once the layout patterns that match the reference pattern are identified, the association unit 360 may associate the one or more pattern matching hints with the identified layout patterns. Different association operations may be performed. In operations 450A, for example, the association unit 360 outputs or stores (including outputs and stores) the identified layout patterns along with the one or more pattern matching hints. As noted above, with some implementations of the invention, the one or more pattern matching hints may be displayed graphically.

Alternatively or additionally, in operation 450B, the association unit 360 adjusts the identified layout patterns in the layout design based on the one or more pattern matching hints. If there are more than one pattern matching hints, the association unit 360 may determine the best one for the layout design. With some implementations of the invention, the association unit 360 may use a place and route tool to perform the adjustment.

### Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of pattern matching hints, comprising:
receiving layout data for a reference pattern;
determining one or more pattern matching hints for the reference pattern;
storing the one or more pattern matching hints in a processor-accessible medium;
identifying layout patterns in a layout design that matches the reference pattern; and
associating the one or more pattern matching hints with the layout patterns.

2. The method recited in claim 1, wherein the associating comprises:
outputting or storing information of the layout patterns along with the one or more pattern matching hints.

3. The method recited in claim 1, wherein the associating comprises:
adjusting the layout patterns based on the one or more pattern matching hints.

4. The method recited in claim 1, wherein the one or more pattern matching hints comprises pattern-specific repair hints.

5. The method recited in claim 1, wherein the determining one or more pattern matching hints comprises:
evaluating hint candidates based on simulation, fabrication or both.

6. The method recited in claim 5, wherein the simulation comprises lithographic simulation, electrical simulation or both.

7. A processor-readable medium storing processor-executable instructions for causing one or more processors to perform a method of pattern matching hints, the method comprising:
receiving layout data for a reference pattern;
determining one or more pattern matching hints for the reference pattern;
storing the one or more pattern matching hints in a processor-accessible medium;
identifying layout patterns in a layout design that matches the reference pattern; and
associating the one or more pattern matching hints with the layout patterns.

8. The processor-readable medium recited in claim 7, wherein the associating comprises:
outputting or storing information of the layout patterns along with the one or more pattern matching hints.

9. The processor-readable medium recited in claim 7, wherein the associating comprises:
adjusting the layout patterns based on the one or more pattern matching hints.

10. The processor-readable medium recited in claim 7, wherein the one or more pattern matching hints comprises pattern-specific repair hints.

11. The processor-readable medium recited in claim 7, wherein the determining one or more pattern matching hints comprises:
evaluating hint candidates based on simulation, fabrication or both.

12. The processor-readable medium recited in claim 11, wherein the simulation comprises lithographic simulation, electrical simulation or both.

13. A system comprising one or more processors, the one or more processors programmed to perform a method of pattern matching hints, the method comprising:
receiving layout data for a reference pattern;
determining one or more pattern matching hints for the reference pattern;
storing the one or more pattern matching hints in a processor-accessible medium;
identifying layout patterns in a layout design that matches the reference pattern; and
associating the one or more pattern matching hints with the layout patterns.

14. The system recited in claim 13, wherein the associating comprises:
outputting or storing information of the layout patterns along with the one or more pattern matching hints.

15. The system recited in claim 13, wherein the associating comprises:
adjusting the layout patterns based on the one or more pattern matching hints.

16. The system recited in claim 13, wherein the one or more pattern matching hints comprises pattern-specific repair hints.

17. The system recited in claim 13, wherein the determining one or more pattern matching hints comprises:
evaluating hint candidates based on simulation, fabrication or both.

18. The system recited in claim 17, wherein the simulation comprises lithographic simulation, electrical simulation or both.
